(19) United States
(12) Patent Application Publication
(10) Pub. No.: US 2007/0229908 A1
(43) Pub. Date: Oct. 4, 2007

(54) METHOD FOR REGISTERING IMAGE, AND IMAGE PROCESSING APPARATUS

(75) Inventor: Hirotsugu TAKAHATA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/688,994

(22) Filed: Mar. 21, 2007

(30) Foreign Application Priority Data
Mar. 31, 2006 (JP) 2006-098209

(51) Int. Cl. G06K 15/00

(52) U.S. Cl. 358/3.28

(57) ABSTRACT

A method for registering an image data of an image of a registration object by storing in a storage device. The method may include: obtaining an image data of the image of the registration object; analyzing the obtained image data; specifying a kind of the image of the registration object, in accordance with an analyzed result; adding an image kind information, which indicates the specified kind of the image, as an attribute information to the image data of the image of the registration object; and storing the image data to which the attribute information is added, in the storage device. A kind of image is specified by a black pixel ratio of the image data, and the like, may be based on a histogram indicating a concentration distribution of the read image.

### CROSS-REFERENCE TO RELATED APPLICATIONS

This Nonprovisional application claims priority under 35 U.S.C. §119(a) to Japanese Patent Application No. 2006-098209 filed in Japan on Mar. 31, 2006, the entire contents of which are hereby incorporated by reference.

### TECHNICAL FIELD

Aspects of the present invention relate to an image processing apparatus, such as a digital camera that photographs an image and consequently obtains an image data, and a scanner that scans an original document and consequently obtains an image data, and the like, and more particularly relates to a technique for registering the image data obtained by the image processing apparatus. Also, aspects of the present invention relate to a method for registering the image data obtained by the image processing apparatus.

### BACKGROUND

Conventionally, a digital camera is designed such that, when a photographed image data is read, a thumbnail image data is generated from this image data and it is stored as the image file of Exif (EXchange Image File) format, which includes this thumbnail image data, the various information such as a maker name of the digital camera, a preset user name of the camera, a photographed date and the like, and an original image data, in a flash memory and the like.

Also, a scanner is widely spread as an apparatus for reading a hand written or printed original document as an image data. Also the scanner is proposed such that, when the image data is read, a thumbnail image data is generated from this image data, and it is inputted as the image file of the Exif format composed of the original image data and the thumbnail image data to a personal computer (hereafter, referred to as PC) or stored in an external storage media such as a memory card, a USB memory and the like.

### SUMMARY

Aspects of the present invention provide an image processing apparatus which can register image data in a storage device under a state where a user can easily manage them and provide a method for registering such image data.

A method for registering image of one aspect of the present invention proposed to attain the above-mentioned object is a method for registering an image data of an image of a registration object by storing in a storage device, and may include the steps of: obtaining an image data of the image of the registration object; analyzing the obtained image data; specifying a kind of the image of the registration object, in accordance with an analyzed result; adding an image kind information, which indicates the specified kind of the image, as an attribute information to the image data of the image of the registration object; and storing the image data to which the attribute information is added, in the storage device.

An image processing apparatus of other aspect of the present invention proposed to attain the above-mentioned object is an image processing apparatus that registers an image data of an image of a registration object by storing in a storage device, and may include: an image data obtaining unit that obtains the image data of the image of the registration object; an image data analyzing unit that analyzes the image data obtained by the image data obtaining unit; an image kind specifying unit that specifies a kind of the image of the registration object, in accordance with a result analyzed by the image data analyzing unit; an attribute information adding unit that adds an image kind information, which indicates the kind of the image specified by the image kind specifying unit, as an attribute information to the image data of the image of the registration object; and a registering unit that stores the image data to which the attribute information is added by the attribute information adding unit, in the storage device.

In the method for registering image and the image processing apparatus of one of the aspects of the present invention, the obtained image data is analyzed, and the image kind information to specify the kind of the image is specified in accordance with the analysis result. Then, since the specified image kind information is added to the image data and stored in the storage device, the image of a registration object is registered.

The above and further aspects the invention will more fully be apparent from the following detailed description with accompanying drawings.

### BRIEF DESCRIPTION OF THE SEVERAL VIEWS OF THE DRAWINGS

FIG. 1 is a block diagram showing a schematic hardware configuration of MFP (Multiple Function Peripheral) when an image processing apparatus according to one or more aspects of the present invention is applied to an MFP;

FIG. 2A and FIG. 2B are a flowchart showing a procedure of a main routine of a data registering process in the Embodiment 1;

FIG. 3 is an explanatory view showing an example of items of an attribute information that can be added to an image data;

FIG. 4 is a flowchart showing a procedure of an image analyzing process that is included as a subroutine in a data registering process in the Embodiment 1;

FIG. 5A, FIG. 5B and FIG. 5C are histograms exemplifying a concentration distribution of an image;

FIG. 6A and FIG. 6B are a flowchart showing a procedure of a user information setting process that is included as a subroutine in the data registering process of the Embodiment 1;

FIG. 7 is an explanatory view showing detailed setting items at setting of a user name as attribute information;

FIG. 8A and FIG. 8B are a flowchart showing a procedure of a storage destination setting process that is included as a subroutine in the data registering process of the Embodiment 1;

FIG. 9A, FIG. 9B and FIG. 9C are explanatory views showing a detail of a storage destination path information;

FIG. 10A and FIG. 10B are a flowchart showing a procedure of an image file generating process that is included as a subroutine in the data registering process of the Embodiment 1;

FIG. 11 is an explanatory view showing a detail displaying of a folder in which an image file is stored;

FIG. 12 is a functional block diagram showing a schematic functional configuration of the image processing apparatus according to one or more aspects of the present invention; and

FIG. 13A and FIG. 13B is a flowchart showing a procedure of a main routine of a data registering process in an Embodiment 2.

### DETAILED DESCRIPTION

The one or more embodiments of the present invention will be described below with reference to the drawings. Hereafter, it is noted that a case where an image processing apparatus according to one or more aspects of the present invention is applied to an MFP (Multiple Function Peripheral) is explained.

It is noted that various connections are set forth between elements in the following description. It is noted that these connections in general and, unless specified otherwise, may be direct or indirect and that this specification is not intended to be limiting in this respect.

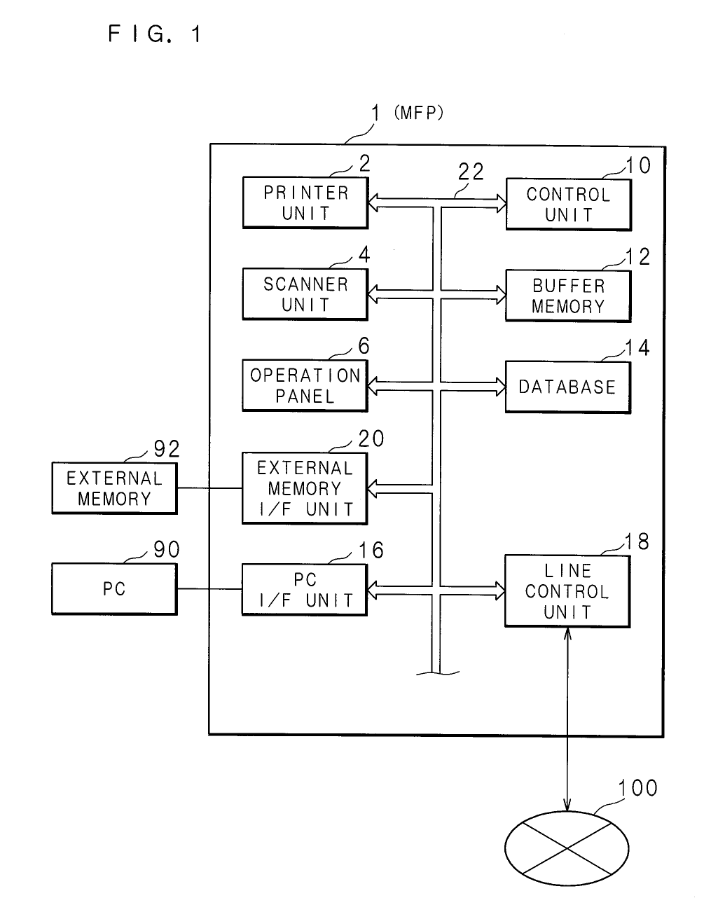

FIG. 1 is a block diagram showing a schematic hardware configuration of the MFP 1 as an image processing apparatus according to one or more aspects of the present invention.

The MFP 1 is configured so as to be able to realize respective functions of: a scanner function for reading an image of an original document as an image data; a printer function for printing an image indicated as an image data on a print paper; a copy function where the scanner function and the printer function are combined; and a facsimile function for transmitting and receiving the image data through the PSTN (Public Switched Telephone Network) 100 and once storing the received image data in a memory (a buffer memory 12 or the like) and then printing on the paper.

Specifically, the MFP 1 is provided with a printer unit 2, a scanner unit 4, an operation panel 6, a control unit 10, the buffer memory 12, a database 14, a PC interface unit (hereafter, referred to as a PC I/F unit) 16, a line control unit 18 and the like, as shown in FIG. 1, and the respective components are connected to each other through a bus line 22.

The printer unit 2, by receiving a command from the control unit 10, feeds the papers as the recording medium from a paper feeding cassette (paper feeding tray), which can store a plurality of papers, one by one, and uses the known image recording method, such as a laser transfer method, an ink jet method and the like, and forms the image based on the image data on the paper and then discharges to a paper discharging tray.

The scanner unit 4 reads the image of the original document set at a predetermined original document read position through the known image sensor, such as a CCD (Charge Coupled Device), a CIS (Contact Image Sensor) and the like, in accordance with the command from the control unit 10, and generates the image data representing the read image.

The operation panel 6 is provide with a display unit that uses, for example, an LCD to display an operation state of the MFP 1 and the like, and a plurality of operation buttons to input the various commands.

In the buffer memory 12, the image data received through the PC I/F unit 16 or line control unit 18 and the image data read by the scanner unit 4 are temporarily stored.

The database 14 is constructed in a rewritable non-volatile memory (for example, an EEPROM, an HDD and the like). The control parameters required when the control unit 10 executes various processes, the data of a telephone directory including names of persons, company names, telephone numbers, facsimile numbers and the like, the various information to be registered by a user such as an attribute information which will be described later, the image file generated in the data registering process which will be described later, are registered in the database 14.

The PC I/F unit 16 is an interface to connect the MFP 1 through a communication cable to a personal computer (hereafter, referred to as PC) 90.

The line control unit 18 carries out the line control, such as the transmission of a call signal based on a command from the operation button, the reception of the call signal, and the like. Also, the line control unit 18 converts the image data read by the scanner unit 4 into a modulation signal matched with a frequency band of the PSTN 100 at the time of a facsimile transmission and transmits it at the time of a facsimile reception, and demodulates the modulation signal transmitted through the PSTN and converts into a digital image data. Moreover, a decoding unit and an encoding unit, which are not shown, are connected to the line control unit 18. Thus, the line control unit 18 encodes the image data at the time of the facsimile transmission prior to the conversion into the modulation signal, and decodes the demodulated image data at the time of the facsimile reception.

An external memory I/F unit 20 can directly attach and detach various external memories 92 (for example, a memory card, a USB memory and the like) and can indirectly attach and detach the digital camera by inserting and pulling out the cable connected to the digital camera. When the external memory 92 is attached or when the cable connected to the digital camera is connected, the external memory I/F unit 20 can record and read the data to and from the external memory 92 or digital camera.

The control unit 10 is configured by a known micro computer whose main components are CPU, ROM, RAM and the like. The control unit 10 controls the respective components, in accordance with a command from the user inputted by operating the operation buttons on the operation panel 6 by the user, or a command inputted from the external PC 90 or an external apparatus such as a facsimile apparatus or the like through the PSTN 100, and consequently makes the MFP 1 function as a printer, a scanner, a copying machine, a facsimile or the like.

Specifically, when there is a print request from the PC 90, the control unit 10 receives the image data transmitted from the PC 90 after that, and controls the printer unit 2 and generates the image based on the image data on the paper. Also, when an image reading request is inputted through the PC 90 or operation panel 6 by the user, the control unit 10 controls the scanner unit 4 and consequently reads an image of the original document and then stores the read image data in the database 14 or the external memory 92 attached to the external memory I/F unit 20, in accordance with a preset operation mode, or transmits to the PC 90 and stores in a built-in memory of the PC 90. In accordance with the foregoing procedure, the MFP 1 is operated as the printer or scanner.

Also, when a copy command is inputted through the operation panel 6 from the user, the control unit 10 controls the scanner unit 4 in accordance with an operation mode related to the copy function set at that time and consequently reads the image of an original document set by the user and then stores the read image data in the buffer memory 12. Also, when the reading of the original document has been completed, the control unit 10 controls the printer unit 2 so as to form (copy) the image on a paper based on the image data stored in the buffer memory 12.

Moreover, the control unit 10, when a receiving request of the original document is received through the line control unit 18 from the external apparatus such as the facsimile apparatus or the like, controls the printer unit 2 and consequently forms the image based on the image data transmitted from the facsimile apparatus after that, on the paper. Also, when a facsimile transmission command is inputted through the operation panel 6 from the user, the control unit 10 controls the scanner unit 4 in accordance with the operation mode related to the facsimile function set at that time and consequently reads the image of the original document set by the user and then transmits the read image data through the line control unit 18 to an indicated transmission destination.

On the other hand, when the settings (the various detailed settings with regard to the copy function, the facsimile function, the scanner function and the printer function) of the various operation modes of the MFP 1 are inputted through the PC 90 or the operation panel 6 from the user, the control unit 10 displays a screen for setting the operation mode on the display unit in accordance with the inputted command. Then, the control unit 10 reads the command inputted by the user in accordance with the displayed screen, and stores the information corresponding to the read command in the suitable storage region such as the RAM, the database 14 or the like, and consequently sets the operation mode of the MFP 1. For example, when the user inputs an image quality information such as a resolution, a tone and the like when the scanner unit 4 reads the image, the storage destination of the read image data, and the like, the control unit 10 stores the inputted information in the database 14.

As mentioned above, the control unit 10 executes, by controlling the scanner unit 4, the process for reading the image from the original document and storing the image data in the various memories. Incidentally, the MFP 1 as the image processing apparatus according to one or more aspects of the present invention, especially when the image data is read by the scanner unit 4, executes a data registering process, which adds to the image data the various information (hereafter, also referred to as attribute information) indicating the detail of the read image data, in response to the command from the user, and stores as the image file of the Exif (EXchange Image File) format in the memory such as the database 14, the external memory 92, the PC 90 or the like.

It is noted that the Exif format is the format where the various information can be added with JPEG as a base.

### Embodiment 1

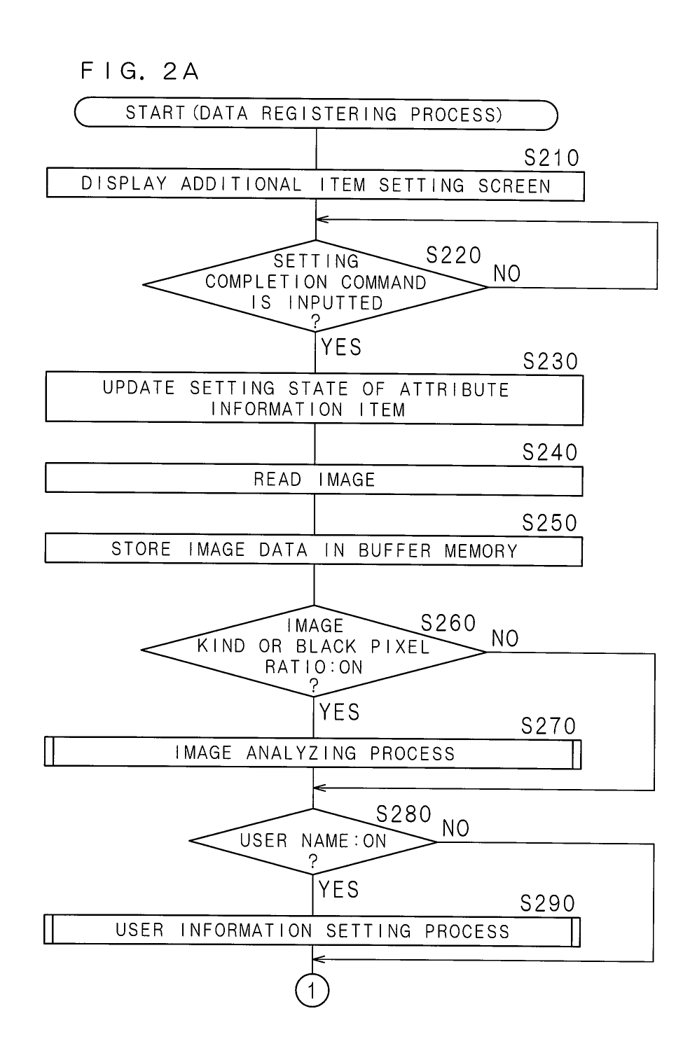

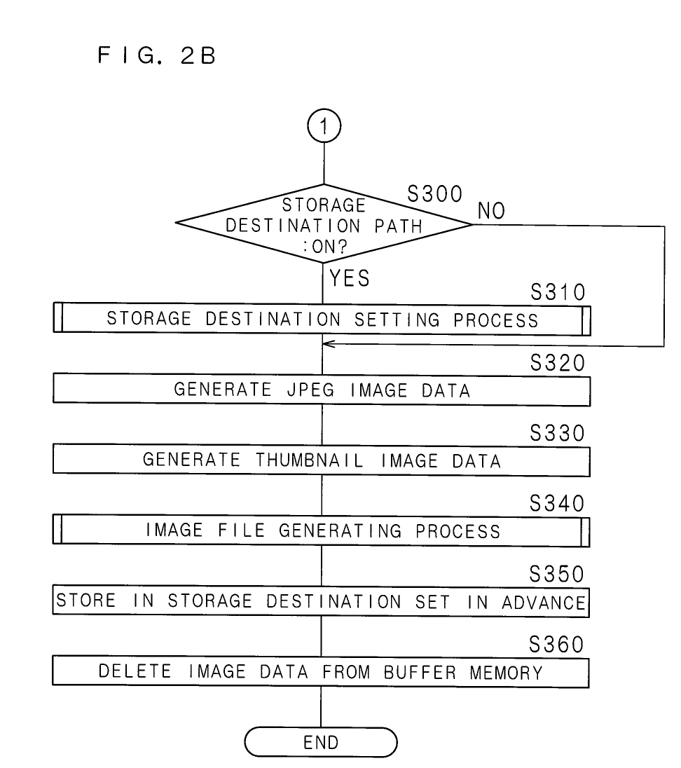

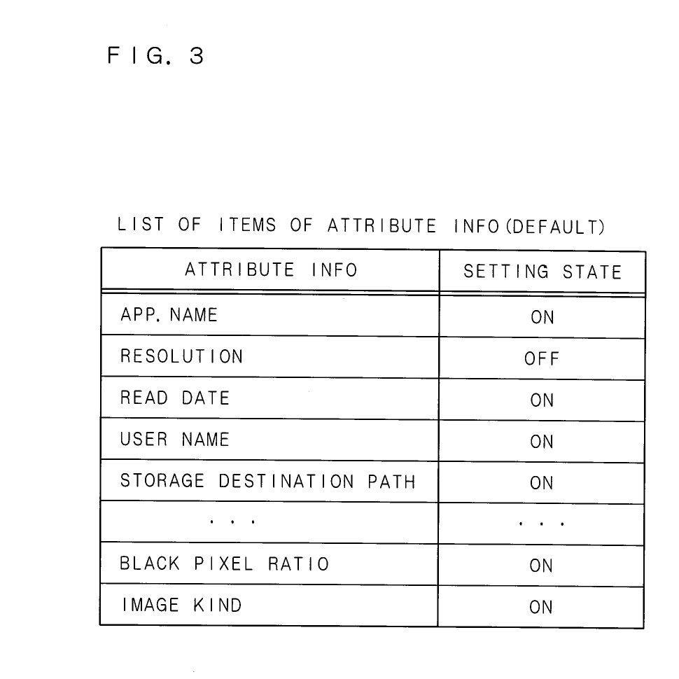

The Embodiment 1 of the data registering process executed by the control unit 10 of the MFP 1 will be described below by referring FIG. 2A, FIG. 2B and FIG. 3. FIG. 2A and FIG. 2B is a flowchart showing a main routine of a procedure of the data registering process of the Embodiment 1 executed by the control unit 10 of the MFP 1, and FIG. 3 is an explanatory view showing an example of items of the attribute information that can be added to the image data.

The data registering process of the MFP 1 is started when the image reading request by the user is inputted through the PC 90 or operation panel 6.

At first, the control unit 10 displays an additional item setting screen on the display unit of the PC 90 or the operation panel 6 in response to the request (Step S210). The additional item setting screen is composed of a list of: respective items of the attribute information that can be added to the read image data, in accordance with the information stored in the database 14 in advance; and the setting state (ON/OFF) indicating whether or not each item is added.

Here, as the attribute information, as shown in FIG. 3, there is: peculiar information of the MFP 1 such as an apparatus name and the like; environment information such as a read date and the like at the time of reading; setting information such as a user name, a storage destination path, image quality information of a resolution and the like at the time of reading or preset; a black pixel ratio indicating a rate of black pixels in the image; kind information based on the read image, such as an image kind indicating whether the image is a text, a photo or a figure, and the like. The user can select ON or OFF for each item of the attribute information, by operating the operation panel 6.

It is noted that in the data registering process shown in the flowchart of FIG. 2A and FIG. 2B, when the request is inputted from the PC 90, the control unit 10 displays the setting screen and the like on the display unit of the PC 90 and also reads the input from the PC 90. On the other hand, when the request is inputted through the operation panel 6, the control unit 10 displays the setting screen on the display unit of the operation panel 6 and also reads the input from the operation panel 6. However, except for those points, the control unit 10 executes the similar processes for any request. Thus, in the following explanation, the case that the data registering process is performed on a command inputted through the operation panel 6 is explained as the example.

Next, the control unit 10 judges whether or not a setting completion command of the attribute information item is inputted through the operation panel 6 (Step S220). When the setting completion command is judged not to be inputted (Step S220: NO), the control unit 10 repeats the process of the step S220 until the completion command is inputted and becomes in a wait state until the completion command is inputted. On the other hand, when the setting completion command is judged to be inputted (Step S220: YES), the control unit 10 reads the content set on the additional item setting screen and consequently updates the setting state of the attribute information item (Step S230). Then, by controlling the scanner unit 4, the control unit 10 reads the image of the original document set by the user (Step S240) and stores the image of the read image in the buffer memory 12 (Step S250). At this time, the control unit 10 reads the date (time) from a timer built in the MFP 1 and stores as the read date in the database 14.

Next, the control unit 10 judges whether or not the image kind or the black pixel ratio is set (ON) as the attribute information (Step S260). When any of the items is judged to be set (Step S260: YES), the control unit 10 executes an image analyzing process (Step S270) and then shifts the process to a step S280. It is noted that the image analyzing process at the step S270 is prepared as a subroutine, and its detail will be described later. On the other hand, when any of the above mentioned items is judged not to be set as the attribute information (Step S260: NO), the control unit 10 shifts the process directly to the step S280.

Next, the control unit 10 judges whether or not the user name is set (ON) as the attribute information (Step S280). When the user name is judged to be set as the attribute information (Step S280: YES), the control unit 10 executes a user information setting process (Step S290) and then shifts the process to a step S300. It is noted that the user information setting process at the step S290 is prepared as a subroutine, and its detail will be described later. On the other hand, when the user name is judged not to be set as the attribute information (Step S280: NO), the control unit 10 shifts the process directly to the step S300.

Next, the control unit judges whether or not the storage destination path is set (ON) as the attribute information (Step S300). When the storage destination path is judged to be set as the attribute information (Step S300: YES), the control unit 10 executes a storage destination setting process (Step S310) and then shifts the process to a step S320. It is noted that the storage destination setting process at the step S310 is prepared as a subroutine, and its detail will be described later. On the other hand, when the storage destination path is judged not to be set as the attribute information (Step S300: NO), the control unit 10 shifts the process directly to the step S320.

Then, the control unit 10 generates a JPEG image data and a thumbnail image data, respectively, based on the image data stored in the buffer memory 12 (Step S320 and Step S330). Next, the control unit 10 executes an image file generating process (Step S340). It is noted that the image file generating process at the step S340 is prepared as a subroutine, and its detail will be described later. When the image file generating process has been completed, the control unit 10 stores the generated image file in the storage destination (a specified folder such as the database 14, the external memory 92, the PC 90 or the like) set in advance by the user (Step S350). Finally, the control unit 10 deletes the original image data from the buffer memory 12 (Step S360). As mentioned above, the data registering process is completed.

It is noted that since the methods for generating the JPEG image data and the thumbnail image data at the step S320 and the step S330 are the known technique, their details are omitted.

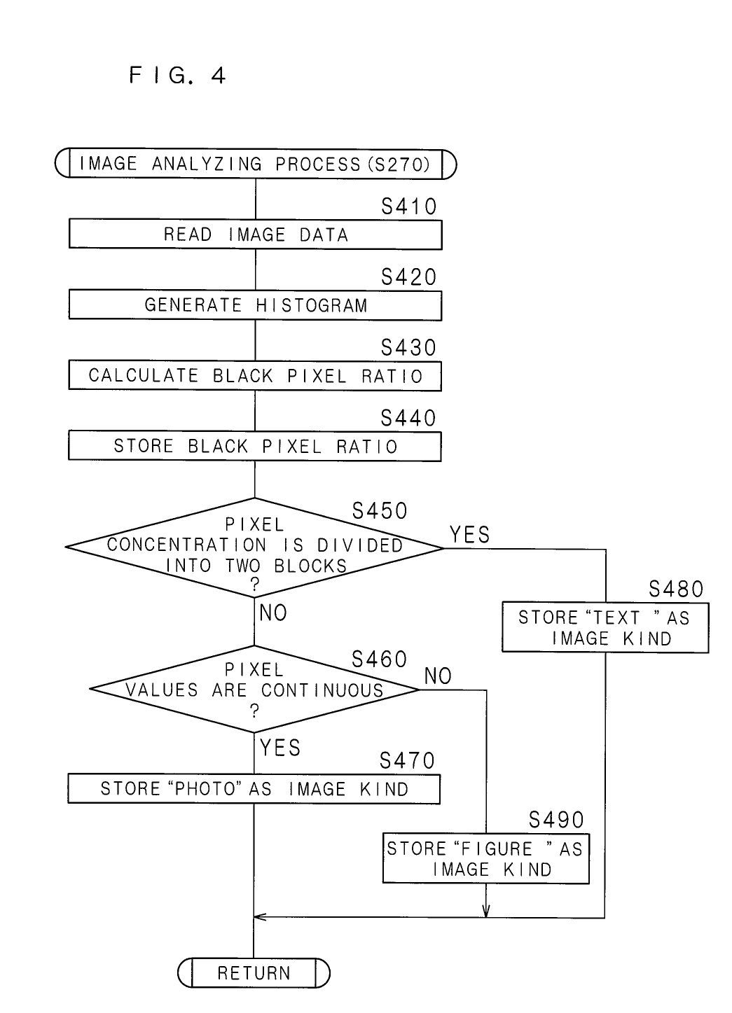

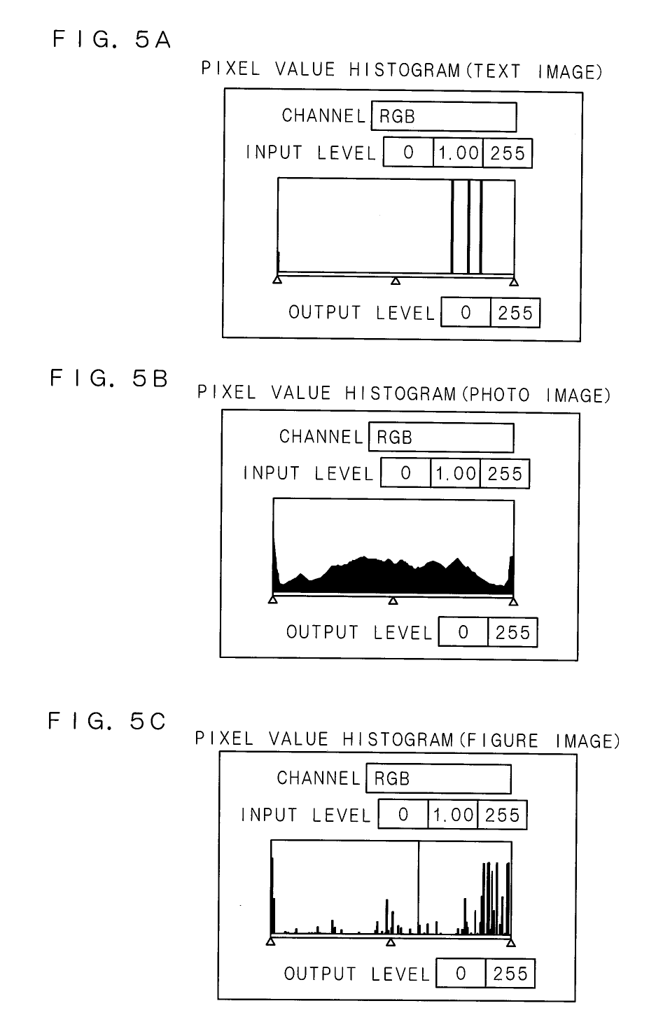

The image analyzing process executed at the step S270 in the flowchart of FIG. 2A will be described below with reference to FIG. 4, FIG. 5A, FIG. 5B and FIG. 5C. FIG. 4 is a flowchart of the subroutine showing the procedure of the image analyzing process to be executed by the control unit 10 of the MFP 1, and FIG. 5A, FIG. 5B and FIG. 5C are schematic views of the histograms showing the concentration distribution of the read image.

When the image analyzing process is started, the control unit 10 firstly reads the image data stored in the buffer memory 12 (Step S410). In succession, the control unit 10 generates the histograms (the vertical axis indicates number of the pixels, and the horizontal axis indicates pixel value) indicating the concentration distribution of the read images, as shown in FIG. 5A, FIG. 5B and FIG. 5C (Step 420). Next, the control unit 10 calculates the black pixel ratio in accordance with the histogram generated at the step S420 (Step S430). It is noted that in this Embodiment 1, the control unit 10 identifies the pixel whose pixel value is a predetermined threshold or more as a black pixel, and calculates the ratio of the pixels identified as the black pixels with respect to all of the pixels, as the black pixel ratio. In succession, the control unit 10 stores the calculated black pixel ratio in the database 14 (Step S440).

Next, the control unit 10 judges whether or not the pixel concentration is divided into two blocks, for example, such as a white region (a region close to a pixel value 0) and the other regions, in accordance with the histogram generated at the step S420 (Step S450). Then, for example, as shown in FIG. 5A, when the histogram is judged to be divided into the two blocks of the white region and the other region (close to a pixel value 200) (Step S450: YES), the control unit 10 judges that the image is a text. In this case, the control unit 10 stores “text” as the image kind in the database 14 (Step S480). In this case, this image analyzing process is completed as mentioned above. Thus, the control unit 10 returns the process to the main routine.

On the other hand, when the histogram is judged not to be divided into the two blocks (Step S450: NO), the control unit 10 judges whether or not the pixel values are continuous (Step S460). As shown in FIG. 5B, when the pixel values are judged to be continuous (Step S460: YES), the control unit 10 judges that the image is a photo. In this case, the control unit 10 stores “photo” as the image kind in the database 14 (Step S470). In this case, since this image analyzing process has been completed as mentioned above, the control unit 10 returns the process to the main routine.

Also, when the pixel values are not continuous, namely, as shown in FIG. 5C, when the pixel values are judged to be dispersed (Step S460: NO), the control unit 10 judges that the image is a figure such as a map or the like. In this case, the control unit 10 stores “figure” as the image kind in the database 14 (Step S490). In this case, since the image analyzing process has been completed as mentioned above, the control unit 10 returns the process to the main routine.

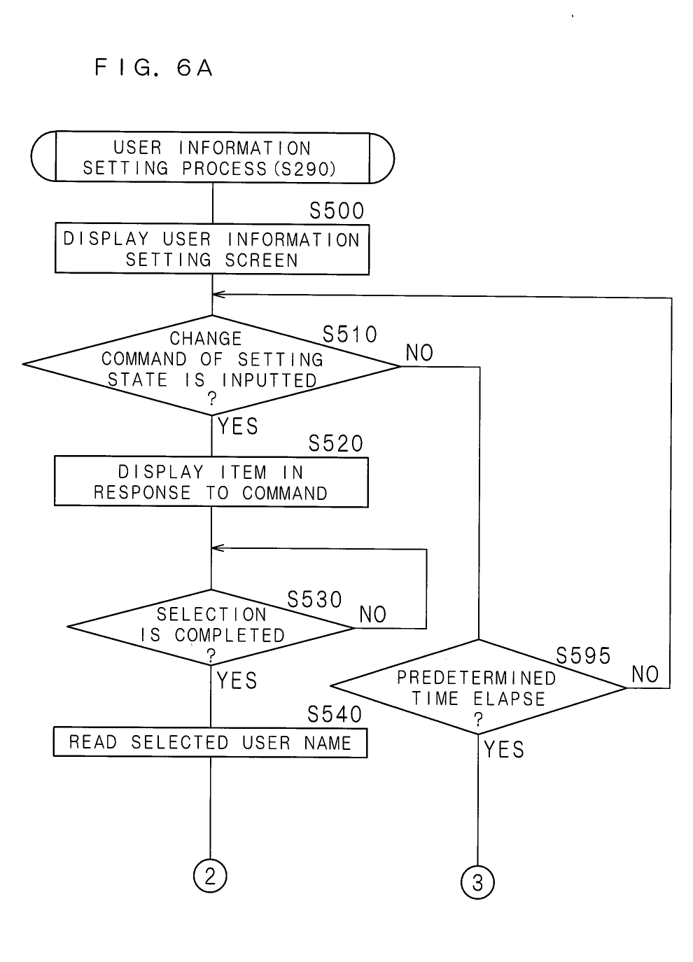

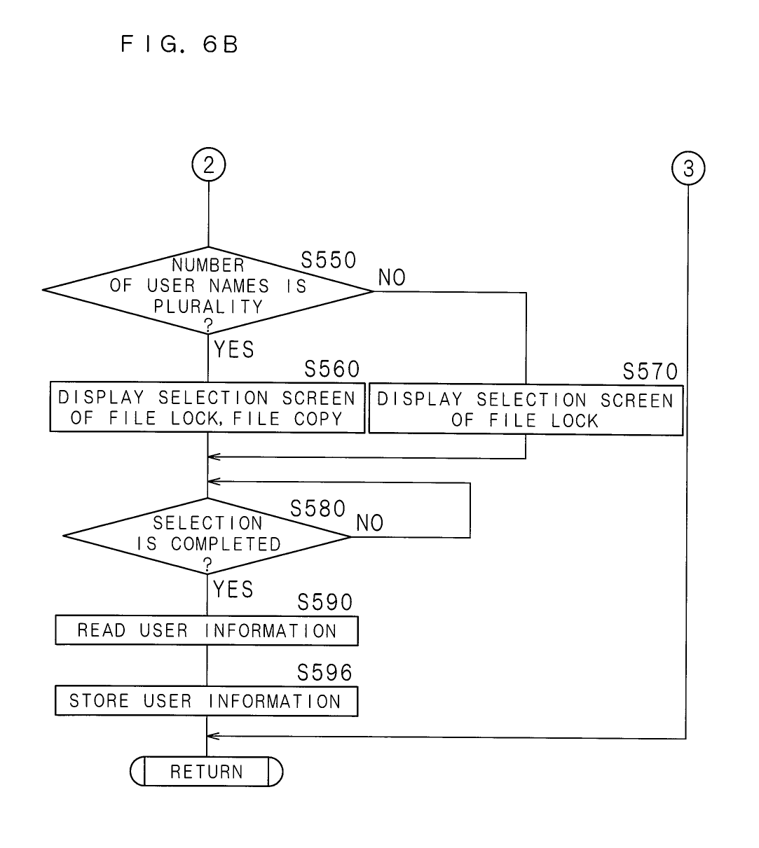

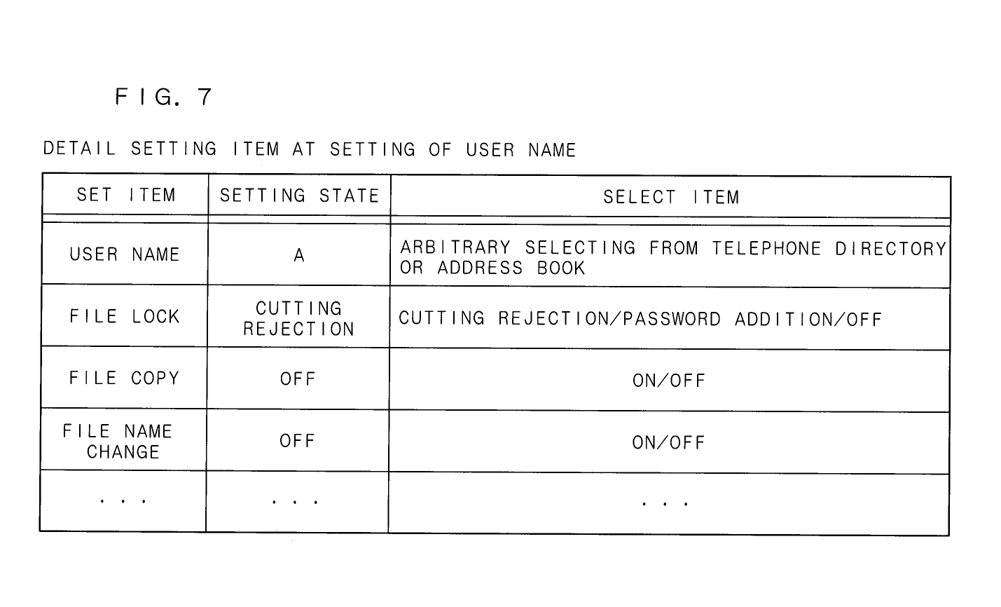

The user information setting process executed at the step S290 of the flowchart of FIG. 2A will be described below with reference to FIG. 6A, FIG. 6B and FIG. 7. FIG. 6A and FIG. 6B are a flowchart of the subroutine showing the procedure of the user information setting process to be executed by the control unit 10 of the MFP 1, and FIG. 7 is an explanatory view showing a detail setting item at the setting of the user name as the attribute information.

When the user information setting process is started, the control unit 10 firstly displays on the display unit of the operation panel 6, in accordance with the user information stored in advance in the database 14, a user information setting screen composed of a list of: a detail setting item at the setting of the user name, such as a user name, a file lock, a file copy, a file name change and the like, as shown in FIG. 7, and the setting states of the respective items (Step S500).

It is noted that the file lock is the item indicating the setting content of the limit information, for example, such as a cutting rejection of the generated image file, a password addition and the like and also indicating whether or not the foregoing limit information is set. The file copy is the item indicating whether or not the generated image file is copied by the number of the user names when the plurality of user names are set. The file name change is the item indicating whether or not the file name is changed for each user name, when the item of the file copy is set (ON) so that the image file is copied by the number of the user names. It is noted that the setting state displayed at the step S500 is displayed such that the content set by a user using the MFP 1 immediately before is displayed in its original state.

Next, the control unit 10 judges whether or not a change command of the setting state is inputted through the operation panel 6 (Step S510). When the change command is judged to be inputted (Step S510: YES), the control unit 10 reads the telephone directory or the like stored in the database 14, in response to the command, and displays a list of the user names on the display unit of the operation panel 6 (Step S520).

Next, the control unit 10 judges whether or not the user name is selected through the operation panel 6 by the user and then a selection completion command is inputted (Step S530). When the selection completion command is judged not to be inputted (Step S530: NO), the control unit 10 repeats the process of the step S530 and becomes in the wait state until the selection completion command is inputted. On the other hand, when the selection completion command is judged to be inputted (Step S530: YES), the control unit 10 reads the selected user name (Step S540).

Next, the control unit 10 judges whether or not the number of the user names read at the step S540 is plurality (Step S550). When the user names is judged to be plurality (Step S550: YES), the control unit 10 displays a selection screen to select whether or not the file lock, the file copy, and the file name change are set (Step S560) and shifts the process to a step S580. On the other hand, when the user names is judged to be single (Step S550: NO), the control unit 10 displays a file lock selection screen to select whether or not the file lock is set (Step S570) and shifts the process to a step S580.

In the situation that any of the selection screens are displayed as mentioned above, the control unit 10 judges whether or not the selection completion command is inputted (Step S580). When the selection completion command is judged not to be inputted (Step S580: NO), the control unit 10 repeats the process of the step S580 and becomes in the wait state until the selection completion command is inputted. On the other hand, when the selection completion command is judged to be inputted (Step S580: YES), the control unit 10 reads the user information such as the selected item, the inputted password and the like (Step S590) and stores it together with the user name read at the step S540 as the new user information in the database 14 (Step S596). In this case, since this user information setting process has been completed as mentioned above, the control unit 10 returns the process to the main routine.

On the other hand, at the step S510, when the change command of the setting state is judged not to be inputted (Step S510: NO), the control unit 10 judges whether or not a predetermined time elapses from the time point when the user information setting screen is displayed (Step S595). Until the elapse of the predetermined time (Step S595: NO), the control unit 10 executes a loop process of the step S510 and the step S595 and becomes in the wait state until the change command of the setting state is inputted. On the other hand, when the predetermined time is judged to elapse (Step S595: YES), the control unit 10 judges that the user information is not required to be changed from the displayed content, completes this user information setting process and returns the process to the main routine.

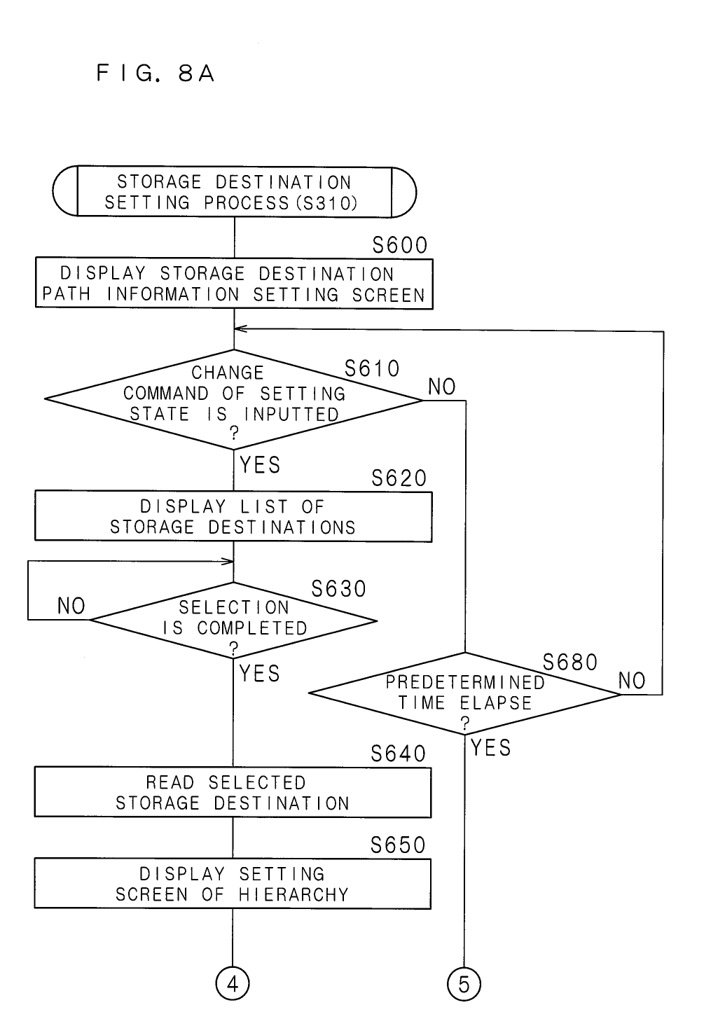

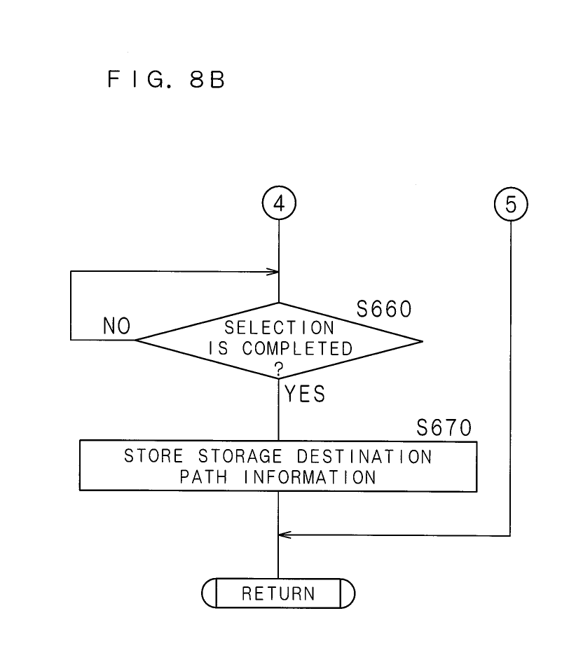

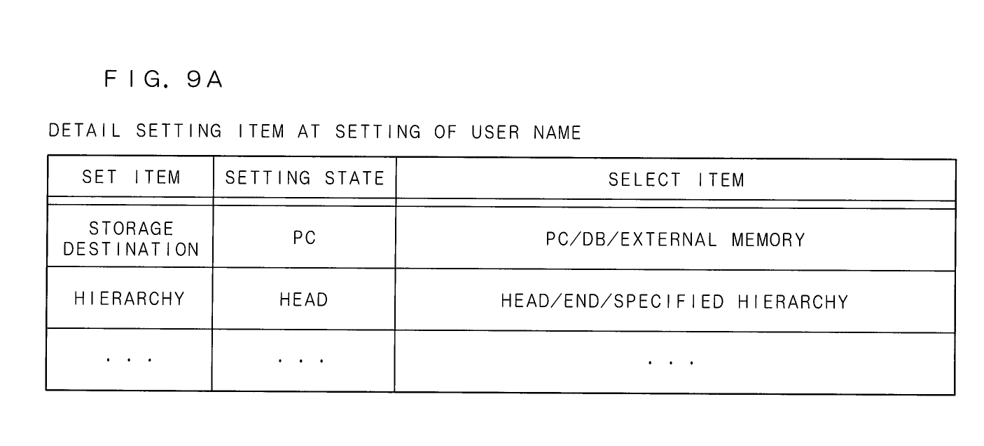

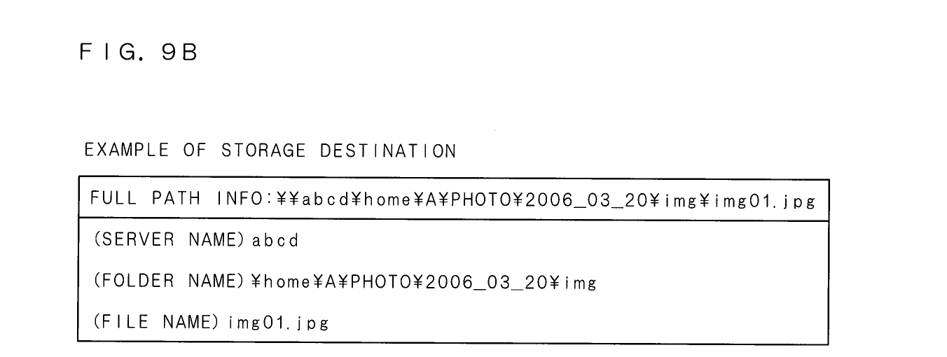

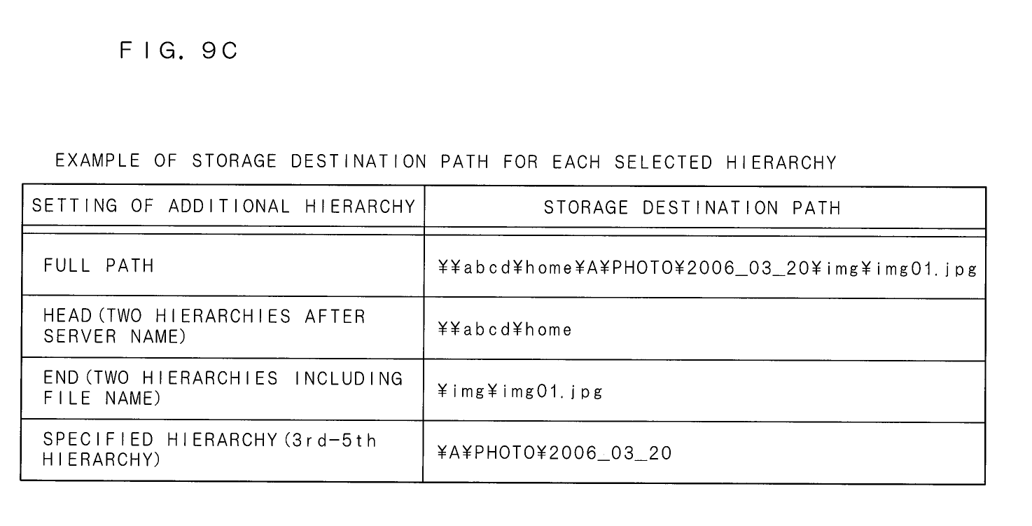

The storage destination setting process executed at the step S310 of the flowchart of FIG. 2B will be described below with reference to FIG. 8A, FIG. 8B, FIG. 9A, FIG. 9B and FIG. 9C. FIG. 8A and FIG. 8B are a flowchart of the subroutine showing the procedure of the storage destination setting process executed by the control unit 10 of the MFP 1. FIG. 9A, FIG. 9B and FIG. 9C are explanatory views showing the detail of the storage destination path information. Specifically, FIG. 9A is an explanatory view showing the detail setting item at the time of setting of the storage destination path information such as the storage destination, the hierarchy and the like, FIG. 9B is an explanatory view showing an example of the storage destination of the image file, and FIG. 9C is an explanatory view showing an example of the storage destination path for each selection hierarchy.

When the storage destination setting process is started, the control unit 10 firstly displays the storage destination path information setting screen composed of: the detail setting item at the time of setting of the storage destination path such as the storage destination, the hierarchy and the like; and a list of the setting states of the respective items, on the display unit of the operation panel 6, as shown in FIG. 9A, in accordance with the storage destination path stored in the database 14 in advance (Step S600).

Here, the storage destination is the item to select the storage destination of the generated image file, such as a folder of the PC 90, a folder of the database 14, a folder of the external memory 92 and the like. Also, the hierarchy as shown in FIG. 9B, is the item to select which of the hierarchies within the full path information composed of the plurality of hierarchies that includes the storage destination and the generated image file name is added to the image file as the storage destination path.

It is noted that the storage destination displayed at this step S600 is the storage destination set in advance through the operation panel 6 by the user. However, when the storage destination is not set in advance, the storage destination set by a user using the MFP 1 immediately before is displayed. On the other hand, as for the hierarchy, a hierarchy set by a user using the MFP 1 immediately before is displayed.

Next, the control unit 10 judges whether or not the change command of the setting state is inputted through the operation panel 6 (Step S610). When the change command is judged to be inputted (Step S610: YES), the control unit 10 displays on the display unit, in response to the command, the list of the storage destinations stored in the database 14 (Step S620).

Next, the control unit 10 judges whether or not the storage destination is selected through the operation panel 6 by the user and then the selection completion command is inputted (Step S630). When the selection completion command is judged not to be inputted (Step S630: NO), the control unit 10 repeats the process of the step S630 and becomes in the wait state until the selection completion command is inputted. On the other hand, when the selection completion command is judged to be inputted (Step S630: YES), the control unit 10 reads the selected storage destination (Step S640).

Next, the control unit 10 displays a full path information composed of: the selected storage destination and the image file names that are sequentially set in accordance with a rule set in advance and displays a setting screen to select the hierarchy that is added as the storage destination path to the image file within this full path information (Step S650). Then, the control unit 10 judges whether or not the selection completion command is inputted (Step S660). When the selection completion command is judged not to be inputted (Step S660: NO), the control unit 10 repeats the process of the step S660 and becomes in the wait state until the selection completion command is inputted. On the other hand, when the selection completion command is judged to be inputted at the step S660 (Step S660: YES), the control unit 10 stores the selected hierarchy part within the full path information as a new storage destination path in the database 14 (Step S670). In this case, since this storage destination setting process has been completed as mentioned above, the control unit 10 returns the process to the main routine.

It is noted that as the storage destination path stored in the database 14 at the step S670, for example, when the full path information is “¥¥abcd¥home¥A¥PHOTO¥2006_{—}03_{—}20¥img¥img01jpg” composed of a server name, a folder name and an image file name, as shown in FIG. 9B, and the head (the two hierarchies after the server name) is selected as the hierarchy, as shown in FIG. 9C, only “¥¥abcd¥home” is stored as the storage destination path in the database 14. Also, for example, when the third to fifth hierarchies are selected as the hierarchy, only “¥A¥PHOTO¥2006_{—}03_{—}20” is stored as the storage destination path in the database 14.

On the other hand, at the step S610, when the change command of the setting state is judged not to be inputted (Step S610: NO), the control unit 10 judges whether or not a predetermined time elapses from the time point when the storage destination path information setting screen is displayed (Step S680). Then, until the elapse of the predetermined time (Step S680: NO), the control unit 10 executes a loop process of the steps S610 and S680 and becomes in the wait state until the change command of the setting state is inputted. On the other hand, when the predetermined time is judged to elapse (Step S680: YES), the control unit 10 judges that it is not required to be changed from the content where the storage destination path is displayed, and completes this storage destination setting process and then returns the process to the main routine.

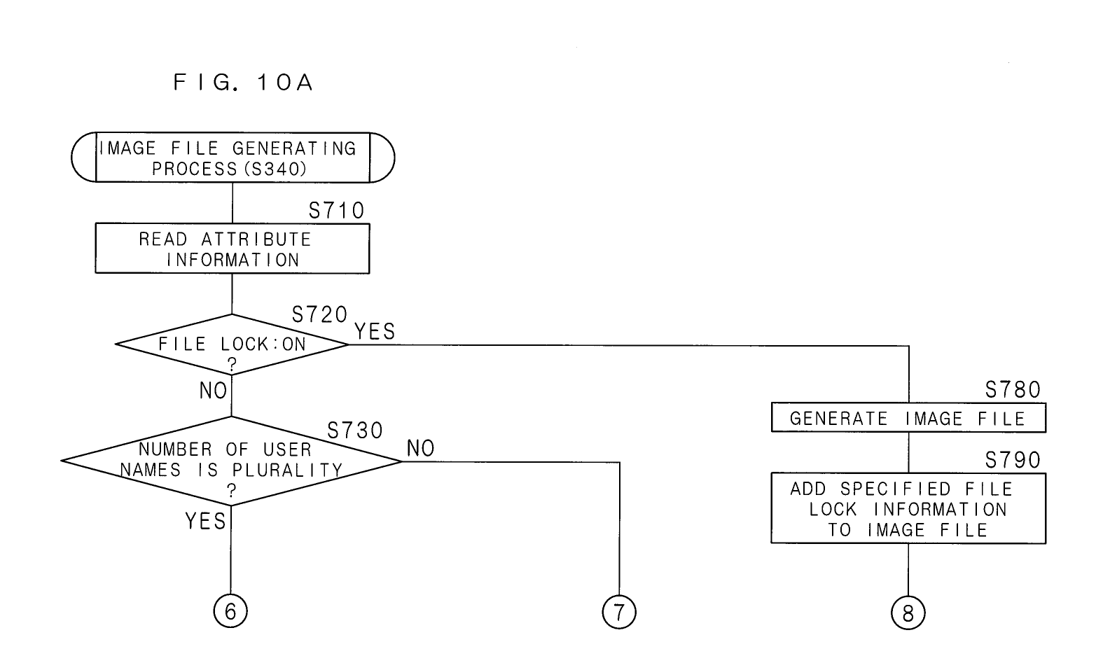

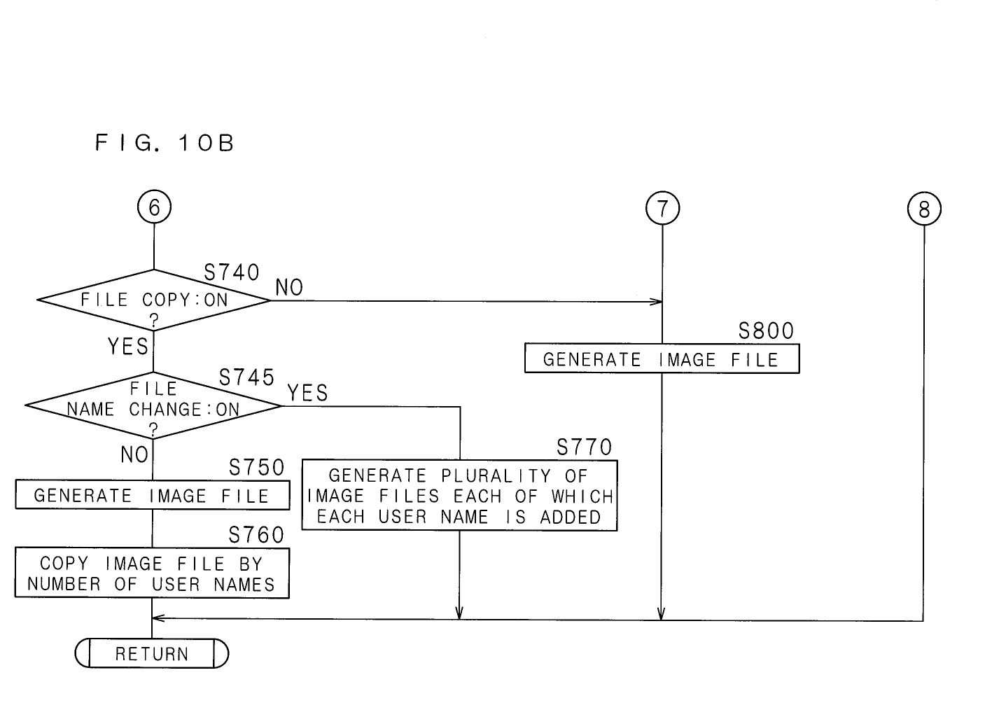

The image file generating process executed at the step S340 of the flowchart of FIG. 2B will be described below with reference to FIG. 10A and FIG. 10B. FIG. 10A and FIG. 10B are a flowchart of a subroutine showing the procedure of the image file generating process executed by the control unit 10 of the MFP 1.

When the image file generating process is started, the control unit 10 firstly reads the various attribute information that should be added to the image data such as a peculiar information, an environment information, a setting information of the image quality information and the like, the kind information and the like, which are stored in the database 14 (Step S710). In succession, the control unit 10 judges whether or not the file lock is set (ON) as the user information (Step S720). When the file lock is judged not to be set (Step S720: NO), the control unit 10 next judges whether or not the plurality of user names are set as the user information (Step S730).

Then, when the plurality of user names are judged to be set (Step S730: YES), the control unit 10 further judges whether or not the file copy is set (ON) as the user information (Step S740). When the file copy is judged to be set (Step S740: YES), the control unit 10 next judges whether or not the file name change is set (ON) as the user information (Step S745). Then, when the file name change is judged to be set (Step S745: YES), the control unit 10 generates the plurality, specifically by the number of the user names, of image files of the Exif format, from the JPEG image data and the thumbnail image data which are generated at the steps S320 and S330 at the time of the data registering process, respectively, and the attribute information read at the step S710, (Step S770). In this case, since this image file generating process has been completed as mentioned above, the control unit 10 returns the process to the main routine.

It is noted that at the step S770, each image file is generated while one of the plurality of set user names is defined as the user name. Moreover, the user name as same as the user name included in the file is added to the file name of each image file.

On the other hand, when the file name change is judged not to be set at the step S745 (Step S745: NO), the control unit 10 generates the image file of the Exif format from the JPEG image data and the thumbnail image data which are generated at the steps S320 and S330, respectively, and the attribute information read at the step S710 (Step S750) and copies the generated image file of the Exif format by the number of the set user names (Step S760). In this case, since this image file generating process has been completed as mentioned above, the control unit 10 returns the process to the main routine.

Moreover, at the step S720, when the file lock is judged to be set (Step S720: YES), the control unit 10 generates the image file of the Exif format from the JPEG image data and the thumbnail image data, which are generated at the steps S320 and S330, respectively, and the attribute information read at the step S710 (Step S780) and adds the set file lock information (Step S790). In this case, since this image file generating process is completed as mentioned above, the control unit 10 returns the process to the main routine. It is noted that at the step S790, for example, the process for adding the information, which disables the cutting from the stored folder, to the generated image file of the Exif format, or converting into the image file with a password by which its opening is limited, in accordance with the inputted password.

Also, at the step S730, when the plurality of user names are judged not to be set (Step S730: NO), or at the step S740, when the file copy is judged not to be set (Step S740: NO), the control unit 10 generates the image file of the Exif format from the JPEG image data and the thumbnail image data, which are generated at the steps S320 and S330, respectively, and the attribute information read at the step S710 (Step S800). In this case, since this image file generating process has been completed as mentioned above, the control unit 10 returns the process to the main routine. It is noted that, since the technique of the method for generating the image file of the Exif format is known, its detail is omitted.

As explained above, in the Embodiment 1, when the image reading request is inputted through the PC 90 or operation panel 6 by the user, the control unit 10 of the MFP 1 reads the image through the scanner unit 4, generates the image data and generates the histogram indicating the concentration distribution of the read image, in accordance with the pixel values of the respective pixels constituting the generated image data. Then, the control unit 10 specifies the kind information, such as the black pixel ratio of the image data, the image kind indicating the kind of the image, and the like, in accordance with the generated histogram, and further adds the specified kind information to the image data and then stores in a predetermined storage destination.

Thus, in the Embodiment 1, the black pixel ratio based on the concentration distribution of the read image and the kind information with regard to the kind of the image such as the image kind and the like are added to the image data registered in the specified folder such as the PC 90, the database 14 and the like. Thus, the user can easily identify the kind of the image on the basis of these information. Hence, it becomes easy to manage the stored image data. That is, the user can easily identify whether the image is the text, the photo or the figure, from the image kind. Also, the user can identify the brightness of the image from the black pixel ratio, namely, can identify whether the read image is the dark image or the bright image.

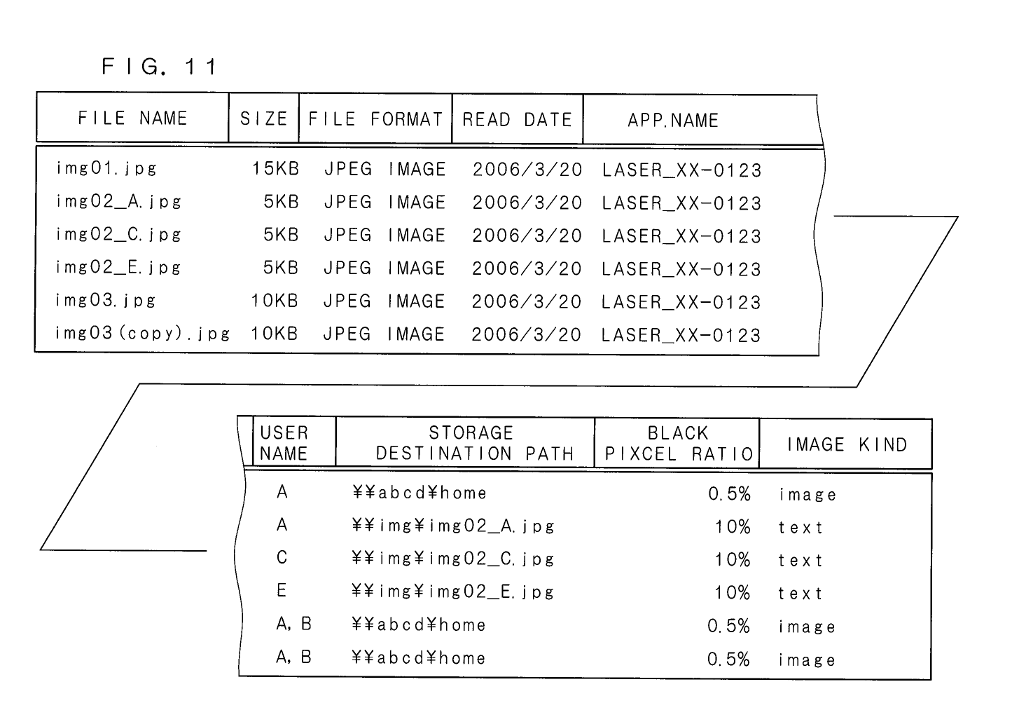

Also, according to the Embodiment 1, together with the kind information with regard to the kind of the read image, the peculiar information of the MFP 1 such as the apparatus name set in advance and the like, the environment information when the read date of the image and the like are read, the setting information when the user name, the storage destination path, the resolution and the like are read or where they are set in advance can be added as the attribute information. For this reason, for example, when the folder that stores the image file is opened to execute the detailed displaying, as shown in FIG. 11, the attribute information is displayed correspondingly to the file name. Thus, the user can more easily identify and classify the image data, in accordance with the attribute information.

It is noted that the image file whose file name shown in FIG. 11 is “img0.1jpg” is the image file whose head is selected as the hierarchy of the storage destination path when the file is generated. Also, the three image files whose file names are “img02_A.jpg”, “img02_C.jpg” and “img02_E.jpg” are the image files generated in accordance with the same image data, when the file copy is set ON and the file name change is set ON, respectively. Then, as “User Name” of the respective files, A, C or E is added one by one, and the same user names as them are also added to “File Name”.

On the other hand, the two image files whose file names are “img03.jpg” and “img03(copy).jpg” are the image files generated in accordance with the same image data, when the file copy is set ON and the file name change is set OFF. Then, as “User Name” of the respective files, a plurality of A and B are both added. It is noted that FIG. 11 is an explanatory view showing the detailed displaying of the folder that stores the generated image file.

Also, in the database 14, the telephone directory, the list of the storage destination and the like are stored. This is configured such that “User Name” and “Storage Destination” are extracted in accordance with the command from the operation panel 6. Thus, the user can easily set “User Name” and “Storage Destination Path” added to the image data, by operating the operation panel 6.

Then, in particular, since “User Name” that enables the identification between the users can be added to the image data as one item of the attribute information, the user can easily identify the image data treated by the user itself.

Also, “Storage Destination Path” indicating the storage destination of the image data can be added as another attribute information to the image data. Thus, for example, when the image data is received from a different user, or even if the image data is moved from the first registration destination, the user can know the registration destination where the image data is firstly registered or can specify the apparatus where the image data is generated, from the registration destination.

Then, in particular, the information of the hierarchy set by the user within the path information composed of the plurality of hierarchies is extracted, and the extracted information is added as the storage destination path to the image data. Thus, the user can protect the unnecessary information from being added to the image data, by setting only the hierarchy that is desired to be used for the identification or classification. Also, since the path information becomes short, the user can easily read the necessary information.

Also, since the plurality of user names can be added as the attribute information, the plurality of users can easily identify the image data to be used by the users themselves in accordance with the respective user names. Then, when the plurality of user names are set as the attribute information, it is possible to set whether or not the image file is copied by the same number as the user names. Thus, the user can store the same image file in the storage destination by the number of the users, as necessary. For this reason, each user can freely use the same image data. Moreover, even if the image file composed of the same image data is copied by the number of the user names, as shown in FIG. 11, “File Name” of each file includes the user name. Hence, each user can easily recognize the image data to be used by the user itself.

Also, when “User Name” is set as the attribute information, it is possible to set the cutting rejection from the folder of the storage destination of the generated image file and set the limit of the opening by the password. Thus, the treatment of the image data in the folder of the storage destination is limited, which can make the security of the image data higher. In short, it is possible to protect the image file from being moved to a different folder and also possible to protect the content of the image data from being viewed by a user who does not know the password.

Then, the image data can be stored as the image file of the Exif format in the folder of the storage destination. Thus, the image data can be easily treated and can be stored in the memory card for the digital camera.

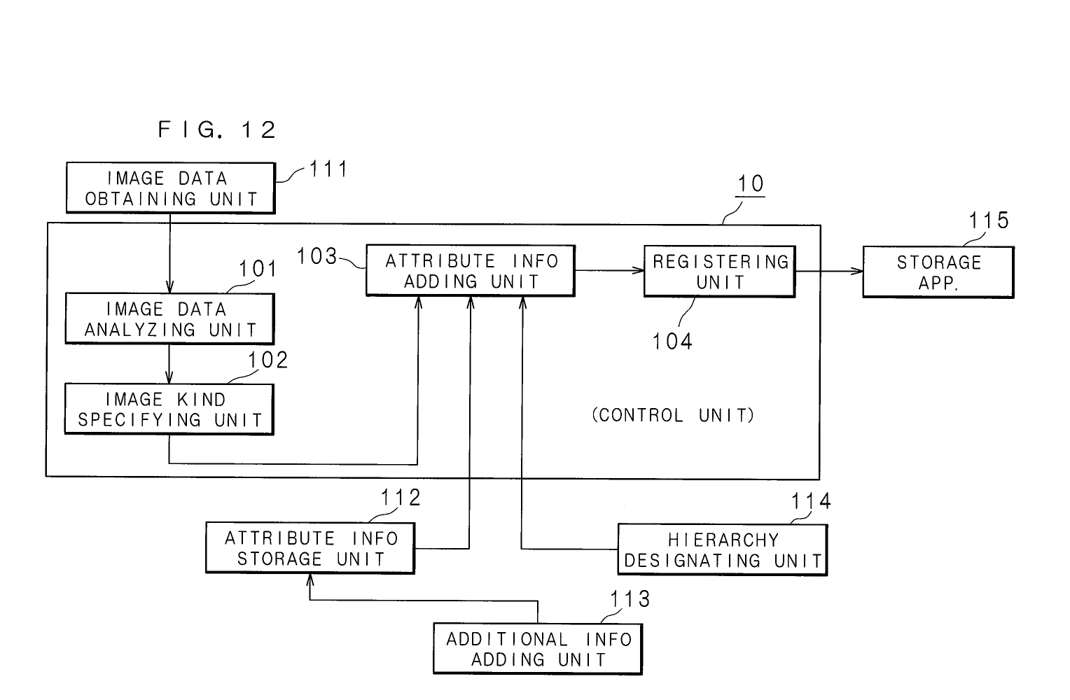

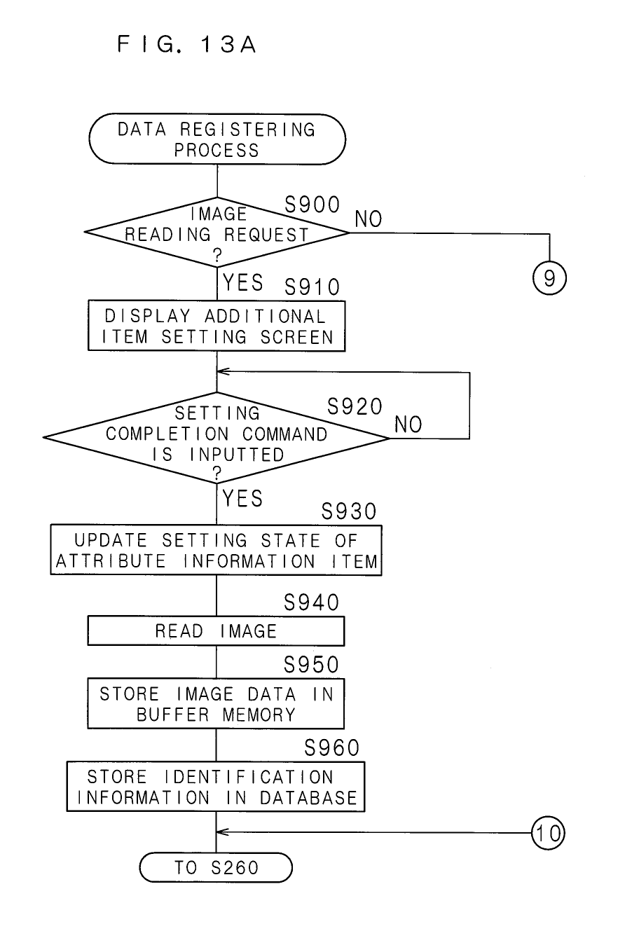

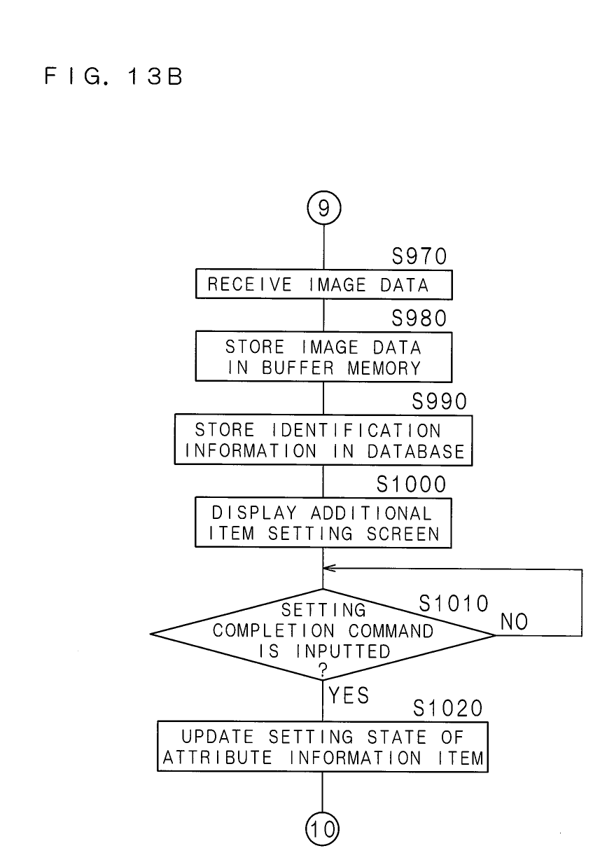

A schematic functional configuration of the image processing apparatus according to one or more aspects of the present invention is shown in a functional block diagram of FIG. 12.

An image data obtaining unit 111 is, specifically, the scanner unit 4, the line control unit 18, and the like, obtains the image data and gives to the control unit 10. An attribute information storing unit 112 is, specifically, the database 14, and stores various attribute information. An additional information setting unit 113 and a hierarchy designating unit 114 is, specifically, the operation panel 6, and is used for specifying the additional information by the user and for specifying the hierarchy of the path information by the user, respectively. A storage apparatus 115 is, specifically, the specified folder of the database 14, the external memory 92, the PC 90 or the like, and is specified as the storage destination of the image data. In other words, the image of a registration object is registered in the specified folder of the database 14, the external memory 92, the PC 90 or the like.

The control unit 10 functions, by executing aforementioned each flowchart, as an image analyzing unit 101, an image kind specifying unit 102, an attribute information adding unit 103, and a registering unit 104, respectively

More specifically, the control unit 10 functions as the image data analyzing unit 101 by executing the process of the steps S410 and S420, functions as the image kind specifying unit 102 by executing the process of the steps S430, S450 through S490, and functions as the attribute information adding unit 103 by executing the process of the steps S750, S770, S780 through S800.

As mentioned above, the Embodiment 1 as relating to one or more aspects of the present invention has been explained. However, naturally, the various variations can be adopted in the Embodiment 1.

For example, as a variation in the MFP 1, it is possible to employ the configuration where the image file of the Exit format is generated and stored in the predetermined storage destination, because the process similar to the image data read by the scanner unit 4 is also performed on the image data received through the line control unit 18, as well as the generation of the image file from the image data read by the scanner unit 4. Then, in such a case, the identification information indicating whether the image data is the image data read by the scanner unit 4 or the image data received through the line control unit 18 may be configured so as to be set as the attribute information.

### Embodiment 2

The Embodiment 2 of the data registering process as relating to one or more aspects of the present invention will be described below with reference to FIG. 10A and FIG. 10B. FIG. 10A and FIG. 10B is a flowchart showing a procedure of a data registering process of the Embodiment 2 executed by the control unit 10 of the MFP 1.

The data registering process of the Embodiment 2 is started when the image reading request is received from the user through the PC 90 or operation panel 6, or when the receiving request of the image data is received through the line control unit 18.

At first, the control unit 10 judges whether or not the inputted request is the image reading request (Step S900). Then, when it is judged to be the image reading request (Step S900: YES), the control unit 10 shifts the process to a step S910. It is noted that, since the processes at following steps S910 to S950 are as same as the processes at the steps S210 to S250 of the flowchart of FIG. 2A of the Embodiment 1, their explanations are omitted.

Then, when the process of the step S950 (the process of the step S250 in the Embodiment 1) has been completed, the control unit 10 stores the identification information (for example, “scanner”) indicating that the image data is the image data read by the scanner unit 4 as the attribute information in the database 14 (Step S960). After that, the control unit 10 executes the processes as same as the processes after the step S260 in the Embodiment 1.

On the other hand, at the step S900, when the inputted request is judged not to be the image reading request (Step S900: NO), namely, when the request is judged to be the receiving request of the image data inputted through the line control unit 18, the control unit 10 receives the image data (Step S970) and stores the received image data in the buffer memory 12 (Step S980).

Next, the control unit 10 stores the identification information (for example, “fax”) indicating that the image data is the image data inputted through the line control unit 18 as the attribute information in the database 14 (Step S990) and displays an additional item setting screen on the display unit of the operation panel 6 (Step S1000). It is noted that the additional item setting screen displayed at this step S1000 is constituted by the list of: the item of the attribute information which can be added to the read image data; and the setting state (ON/OFF) indicating whether or not the item is added, in accordance with the information preliminarily stored in the database 14, similarly to the process at the step S910

It is noted that in the Embodiment 2, as the item of the attribute information, the identification information indicating whether the image data is the image data read by the scanner unit 4 or the image data inputted through the line control unit 18 is added, as mentioned above, in addition to the items listed in the Embodiment 1.

Next, the control unit 10 judges whether or not a setting completion command of the attribute information item is inputted through the operation panel 6 (Step S1010). When the setting completion command is judged not to be inputted (Step S1010: NO), the control unit 10 repeats the process of the step S1010 and becomes in the wait state until the completion command is inputted. On the other hand, when the setting completion command is judged to be inputted (Step S1010: YES), the control unit 10 reads the content set on the additional item setting screen and consequently updates the setting state of the attribute information item (Step S1020). After this, the control unit 10 executes the processes as same as the processes after the step S260 in the Embodiment 1.

As explained above, in the Embodiment 2, the control unit 10 of the MFP 1 processes the various image data such as the image data read by the scanner unit 4, or the image data received through the line control unit 18 or the like, and generates the image file. However, the attribute information indicating the detail of the image data is added to the image data. Thus, for example, even if many image files are stored in one folder, the user can easily recognize whether the image file is the image data read by the scanner unit 4 or the image data received by the facsimile, and the management of the image data becomes easy.

Also, in the Embodiment 2, the MFP 1 may be configured such that, when the receiving request of the image data is received through the line control unit 18, it is regarded as the attribute information and for example, a telephone number of a partner, a name of a partner and the like can be set. That is, this may be configured such that the control unit 10, when receiving the receiving request of the image data, obtains the telephone number of the partner and regards this as the attribute information and also stores in the database 14 and further retrieves, for example, a company name, a personal name or the like which corresponds to the obtained telephone number from the telephone directory stored in the database 14, and then stores as the attribute information in the database 14. With the foregoing configuration, the user can easily identify (a facsimile apparatus) of a transmission source, in addition to the fact that the image data is received by the facsimile.

### Another Embodiment

Incidentally, in the respective Embodiments, the image processing apparatus relating to one or more aspects of the present invention is applied to the MFP 1 having the scanner function. However, it is not limited to the MFP 1. As the image processing apparatus, it may be the apparatus that can generate the image data. For example, it can be constituted by using the scanner apparatus, or the facsimile apparatus or the digital camera merely having only the scanner function.

Moreover, as the image processing apparatus according to one or more aspects of the present invention, it may be the apparatus that can obtain the image data. Thus, for example, it can be constituted by the facsimile apparatus or the mobile telephone with a camera.

On the other hand, the Embodiment 1 employs the configuration that the histogram indicating the concentration distribution of the image is generated in accordance with the pixel values of the respective pixels constituting the image read by the scanner unit 4, and the black pixel ratio and the image kind are specified in accordance with the concentration distribution and added to the image data. However, as the kind information, various information can be naturally used in addition.

For example, this may be configured such that the known image processing method disclosed in Japanese Patent No. 3504054 and the like is used to identify whether the image is a text, a photo, a table, a graph, a figure or the like, and then add the identified result as the kind information to the image data. Also, moreover, this may be configured such that the known image recognizing method for recognizing a human from the image data is used and add the information indicative of the image including the human.

On the other hand, when the image is read by the scanner unit 4, the selection screen for selecting the kind of the image, such as the text, the photo, the table, the graph, the figure and the like, is displayed on the display unit, and the kind of the image is selected through the operation panel 6 by the user, and the kind of the image selected by the user can be added to the image data.

Also, the above-mentioned Embodiments employ the configuration of adding the user name as one item of the attribute information. However, in addition, for example, this may be configured such that the various information enabling the identification between the users, for example, a staff member number and the like are added. Also, this may be configured such that a report destination such as an E-mail address of a user or the like is added. Moreover, the information with regard to the user such as the user name, the staff member number and the like may be set not only from the information of the telephone directory registered in the database of the MFP 1, but also from the information stored in the PC 90.

As mentioned above, according to one or more aspects of the present invention, in the apparatus that directly obtains the image data such as the scanner, the digital camera or the like, or in the apparatus such as the MFP or the like that can receive the image data obtained by the foregoing apparatus, the kind of the image is specified from the analysis result of the image data (for example, the ratio of the black pixels with respect to the white pixels, and the like). Then, the image kind information to specify the kind of the image (for example, the text, the photo, the figure and the like) is added to the image data, and stored in the storage device, such as the memory built in the image processing apparatus, or the memory of the PC connected to the image processing apparatus, or the like. Consequently, the image of the registration object is registered. Thus, the user can easily identify whether the image is the text, the photo, the figure or the like, in accordance with the image kind information added to the image data. Hence, the management of the image data is made efficient.

As aspects of the present invention may be embodied in several forms without departing from the spirit of essential characteristics thereof, the present embodiments are therefore illustrative and not restrictive, since the scope of one or more aspects of the present invention is defined by the appended claims rather than by the description receding them, and all changes that fall within metes and bounds of the claims, or equivalence of such metes and bounds there-of are therefore intended to be embraced by the claims.

What is claimed is:

1. A method for registering an image data of an image of a registration object by storing in a storage device, comprising the steps of:
obtaining an image data of the image of the registration object;
analyzing the obtained image data;
specifying a kind of the image of the registration object, in accordance with an analyzed result;
adding an image kind information, which indicates the specified kind of the image, as an attribute information to the image data of the image of the registration object; and
storing the image data to which the attribute information is added, in the storage device.

2. The method as set forth in claim 1, wherein the image data of the registration object is obtained by:
generating the image data of an image photographed by a photographing apparatus, as the image of the registration object;
reading an image data of an image formed on an original document, as the image of the registration object;
generating the image data of an image received through a facsimile communication, as the image of the registration object, or
receiving the image data of the registration object from an external apparatus.

3. The method as set forth in claim 2, further comprising step of adding an identification information indicating a method from which the image data is obtained, as the attribute information to the image data.

4. The method as set forth in claim 1, wherein
the step of analyzing the obtained image data analyzes the image data of the image of the registration object and obtains a concentration distribution of the image of the registration object, and
the step of specifying a kind of the image specifies a kind of the image of the registration object in accordance with the concentration distribution obtained by the step of analyzing the obtained image data.

5. The method as set forth in claim 4, further comprising the steps of:
storing a plurality of at least one kind of information among user information that enables an identification of a user who is allowed to use the image of the registration object, path information indicating a registration destination in which the image data is stored, and image quality information indicating an image quality of the image of the registration object; and
accepting setting of information among the stored information to be added to the image data of the registration object,
wherein the step of adding attribute information adds at least one kind of the accepted information, as the attribute information to the image data.

6. The method as set forth in claim 5, further comprising the step of specifying a hierarchy to be added to the image data of the registration object within the path information composed of a plurality of hierarchies.

7. The method as set forth in claim 6, wherein the step of adding attribute information adds a plurality of user information.

8. The method as set forth in claim 7, wherein the step of adding attribute information including the steps of:
copying the image data to be registered, by the same number as the plurality of user information, and
adding the plurality of user information to the plurality of copied image data, respectively.

9. The method as set forth in claim 7, wherein the step of adding attribute information including the steps of:
copying the image data to be registered, by the same number as the plurality of user information, and
adding different user information among the plurality of user information to each of the plurality of copied image data, one by one.

10. The method as set forth in claim 1, wherein the step of adding attribute information adds limit information to limit a treatment of the image data, in accordance with information added to the image data to be registered.

11. An image processing apparatus that registers an image data of an image of a registration object by storing in a storage device, comprising:
an image data obtaining unit that obtains the image data of the image of the registration object;
an image data analyzing unit that analyzes the image data obtained by the image data obtaining unit;
an image kind specifying unit that specifies a kind of the image of the registration object, in accordance with a result analyzed by the image data analyzing unit;
an attribute information adding unit that adds an image kind information, which indicates the kind of the image specified by the image kind specifying unit, as an attribute information to the image data of the image of the registration object; and
a registering unit that stores the image data to which the attribute information is added by the attribute information adding unit, in the storage device.

12. The image processing apparatus as set forth in claim 11, wherein the image data obtaining unit obtains the image data of the registration object by:
generating the image data of an image photographed by a photographing apparatus as the image of the registration object;
reading an image data of an image formed on an original document as the image of the registration object;
generating the image data of an image received through a facsimile communication as the image of the registration object, or
receiving the image data of the registration object from an external apparatus.

13. The image processing apparatus as set forth in claim 12, wherein the attribute information adding unit adds an identification information indicating a method from which the image data is obtained by the image data obtaining unit, as the attribute information to the image data.

14. The image processing apparatus as set forth in claim 11, wherein
the image data analyzing unit analyzes the image data of the image of the registration object and obtains a concentration distribution of the image of the registration object, and
the image kind specifying unit specifies a kind of the image of the registration object in accordance with the concentration distribution obtained by the image data analyzing unit.

15. The image processing apparatus as set forth in claim 14, further comprising:
an attribute information storage unit that can store a plurality of at least one kind of information among user information that enables an identification of a user who is allowed to use the image of the registration object, path information indicating a registration destination in which the image data is stored, and image quality information indicating an image quality of the image of the registration object; and
an additional information setting unit that sets information to be added by the attribute information adding unit among the information stored in the attribute information storage unit,
wherein the attribute information adding unit adds at least one kind of the information set by the additional information setting unit, as the attribute information to the image data.

16. The image processing apparatus as set forth in claim 15, further comprising a hierarchy specifying unit that specifies a hierarchy to be added by the attribute information adding unit within the path information composed of a plurality of hierarchies.

17. The image processing apparatus as set forth in claim 16, wherein the attribute information adding unit adds a plurality of user information.

18. The image processing apparatus as set forth in claim 17, wherein the attribute information adding unit copies the image data to be registered, by the same number as the plurality of user information, and adds the plurality of user information to the plurality of copied image data, respectively.

19. The image processing apparatus as set forth in claim 17, wherein the attribute information adding unit copies the image data to be registered, by the same number as the plurality of user information, and adds different user information among the plurality of user information to each of the plurality of copied image data, one by one.

20. The image processing apparatus as set forth in claim 11, wherein the attribute information adding unit adds limit information to limit a treatment of the image data, in accordance with information added to the image data to be registered.
